(19) United States
(12) Patent Application Publication
(10) Pub. No.: US 2024/0233379 A1
(43) Pub. Date: Jul. 11, 2024

(54) METHODS AND APPARATUS TO ENHANCE ACTION SEGMENTATION MODEL WITH CAUSAL EXPLANATION CAPABILITY

(71) Applicant: Intel Corporation, Santa Clara, CA (US)

(72) Inventor: Anthony Rhodes, Portland, OR (US)

(21) Appl. No.: 18/615,839

(22) Filed: Mar. 25, 2024

(51) Int. Cl. G06V 20/40; G06V 10/80; G06V 10/82

(52) U.S. Cl. CPC G06V 20/49; G06V 10/80; G06V 20/41; G06V 20/44; G06V 20/46; G06V 10/82

(57) ABSTRACT

Systems, apparatus, articles of manufacture, and methods are disclosed to enhance action segmentation model with causal explanation capability. An example apparatus includes an interface circuitry to access a pre-trained action segmentation model, instructions, and processor circuitry to at least one of instantiate or execute the machine readable instructions to obtain action segmentation data from the pre-trained action segmentation model, the action segmentation data indicating action prediction for one or more frames of a video sequence, combine the obtained action segmentation data with input features extracted from the one or more video frames, and identify an antecedent action of at least one frame of the video sequence based on pooled importance scores for the frame, the pooled importance scores being calculated from the combined action segmentation data and input features.

### FIELD OF THE DISCLOSURE

This disclosure relates generally to video action segmentation and, more particularly, to methods and apparatus to enhance action segmentation model with causal explanation capability.

### BACKGROUND

Video action segmentation is the process of partitioning an input video into segments, where each segments corresponds to a specific action performed within the video. The video segments identify the boundaries of individual actions or activities, which allows more detailed understanding of the temporal structure and content of the video.

### BRIEF DESCRIPTION OF THE DRAWINGS

FIG. 1 is a block diagram of an example action segmentation process.

FIG. 2 is an example action segmentation process, supplemented with a causal understanding for video action segmentation (CUVAS) to provide causal explainability of actions identified via action segmentation.

FIG. 3 is a block diagram of an example implementation of the causation determiner circuitry to provide causal explanation of per-frame action prediction.

FIG. 4 illustrates calculation of pooled importance scores by neighborhood.

FIG. 5 is a flowchart representative of example machine readable instructions and/or example operations that may be executed, instantiated, and/or performed by example programmable circuitry to implement the causation determiner circuitry of FIG. 3 to render a per-frame action causation prediction.

FIG. 6A illustrates an example experimental results graph for a test video using CUVAS with causation determiner circuitry to provide causal antecedent action prediction.

FIG. 6B illustrates another example experimental results graph for a second test video using CUVAS with causation determiner circuitry provide causal antecedent action prediction.

FIG. 6C illustrates another example experimental results graph for a third test video using CUVAS with causation determiner circuitry provide causal antecedent action prediction.

FIG. 7 is a block diagram of an example processing platform including programmable circuitry structured to execute, instantiate, and/or perform the example machine readable instructions and/or perform the example operations of FIG. 5 to implement the causation determiner circuitry of FIG. 3.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIG. 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Many real-world automation domains require frame-level action segmentation across complex, long duration videos. Moreover, application domains that rely on fine-grain action inference in long-tail data distributions and/or consist of hard to differentiate action classes that can pose significant challenges even for state-of-the-art methods (e.g., manufacturing applications where the “idle” class is predominant and different action classes frequently share strong visual similarities). Examples disclosed herein enhance the explainability and interpretability of video segmentation models, particularly those deployed in challenging, fine-grain action and long-duration settings.

Examples disclosed herein enable Causal Understanding for Video Action Segmentation (CUVAS). Such examples enable improved human understanding and interpretability for action segmentation tasks by supplementing any action segmentation (AS) model with a causal explanation capability. Examples disclosed herein represent a lightweight solution that does not require training and work by propagating gradient information from a pre-trained AS model back to the input features to identify important antecedent frames/actions. The identification of important antecedent frames/actions can help illuminate the causal reasoning underlying the operation of the predictive model, lending an important degree of model interpretability that was inaccessible to users before. For example, in a manufacturing process with multiple sequenced actions, identifying a previous action of highest importance or influence for the current action can provide a more accurate current action prediction.

Making sense of video data (e.g., video classification, scene understanding, object tracking, etc.) is a challenge for deployable artificial intelligence (AI) systems. In particular, precise, fine-grain action segmentation for real-world, long-duration videos is currently an open problem in computer vision and frequently requires human-in-the-loop (HITL) supervision and feedback to achieve state-of-the-art (SOTA) performance, and to reduce training/data acquisition costs. Explainability AI (XAI) techniques can greatly enhance the effectiveness and efficiency of such systems. Examples disclosed herein provide a simple, model-agnostic, and training-free method to better understand the causal reasoning underlying video-based predictive and analytic models. Example approaches disclosed herein can help facilitate better human interaction, build trust in the system, improve the predictive model performance, make training more data efficient, etc.

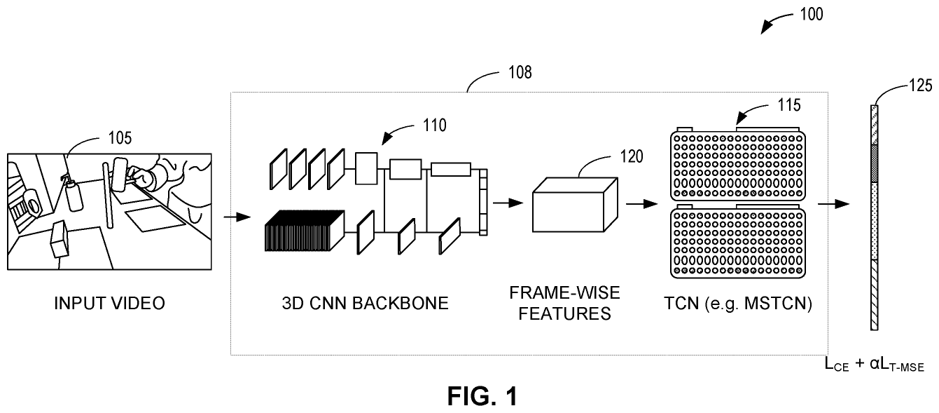

FIG. 1 is a diagram illustrating an example action segmentation (AS) process. The example environment 100 illustrates an example AS workflow. The AS workflow includes an example input video 105, an AS model 108, and a per-frame action prediction 125. The model includes a three-dimensional (3D) convolutional neural network (CNN) feature extractor 110, which produces frame-wise features 120, and a temporal convolution network (TCN) 115.

In the illustrated example of FIG. 1 it is assumed that the AS model 108 trained to output per-frame action prediction 125. The input video 105 can be sequences of frames from a video representing actions or activities.

The 3D CNN feature extractor 110 is a deep learning model used for extracting features from three-dimensional data, such as videos. In some examples, the 3D CNN feature extractor 110 can be a SlowFast architecture for video understanding task. The SlowFast architecture combines two pathways with different temporal resolutions to capture both slow and fast motion information effectively. The slower pathway operates at a low temporal resolution and captures spatial semantics and long-term temporal context. It involves downsampling the input frames to a slower rate. The fast pathway operates at a higher temporal resolution and captures fine-grained temporal information. This involves processing the input frames at the original frame rate.

Both the slow and fast pathways include convolutional neural networks (CNN) serving as backbone networks. The convolutional layers extract spatial features in the input frames. The convolutional layers apply convolutional filters to the input video 105. The filters have a three-dimensional shape, typically with height, width, and depth. The input video is represented as sequence of frames where each frame is represented as a 2D tensor (e.g., an image). The video can be represented as a 3D tensor with dimensions [frame, height, width]. The slower pathway usually has fewer layers with larger spatial kernels to capture broader spatial context, while in the fast pathway, convolutional layers may have smaller spatial kernels to capture finer details.

The convolutional layers are followed by pooling layers which are used for downsampling the feature map produced by the convolutional layers, reducing the spatial dimensions while retaining important information. In some examples, max pooling or average pooling can be used as pooling operations in the 3D CNN 110.

After processing each frame in an input video 105 through the slow and fast pathways, features from both pathways are fused together to form a combined representation referred to as frame-wise features 120. The feature can be fused through various methods such as concatenation, addition, or element-wise multiplication. The fused features are fed into a classification or regression head (e.g., TCN 115) which includes fully connected layers to make predictions for a specific task at hand (e.g., action recognition, object detection, etc.).

During training, the parameters of the 3D CNN 110 are updated using gradient information obtained through backpropagation. Gradients are computed with respect to the loss function, which quantifies the discrepancy between the predicted and ground truth action segmentation labels. The gradients are propagated backward through the layers of the 3D CNN 110 and the network parameters are updated using optimization algorithms such as stochastic gradient descent (SGD) or Adam.

The TCN 115 ingests the CNN-based, frame-wise features 120 and renders the per-frame action prediction 125. The TCN processes frame-wise features 120 extracted from the input video data 105 to model temporal dependencies and make predictions about actions, events, or other temporal phenomena present in the video. The TCN 115 also refines the action segmentation predictions obtained from the 3D CNN 110. The TCN 115 includes one or more layers of temporal convolutional operations. These operations apply convolutional filters along the temporal dimension of the input sequence, capturing temporal relationships between consecutive frames. In some examples, a multi-scale temporal convolutional networks (MSTCN) can be used. The MSTCN includes multiple layers of dilated convolutions with varying dilation rates. MSTCN can capture temporal dependencies at multiple resolutions simultaneously. Output of the TCN 115 is passed through one or more fully connected layers or a SoftMax layer to produce predictions about the input video. These predictions may include action labels assigned to each frame of the video, event boundaries (e.g., the start and end times of actions or events), or other temporal annotations.

During training, TCN 115 also update their parameters using gradient information obtained through backpropagation. Gradients are computed with respect to the loss function, which evaluates the quality of the action segmentation predictions produced by the TCN 115. The gradients are propagated backward through the layers of the TCN 115, and the network parameters are updated using optimization algorithms.

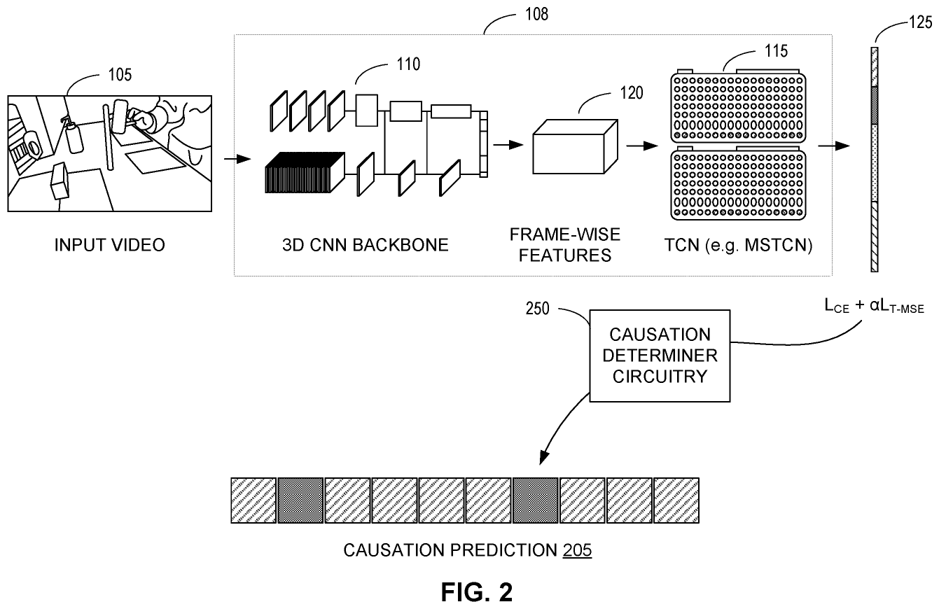

FIG. 2 is an example action segmentation process, supplemented with a causal understanding for video action segmentation (CUVAS) to provide causal explainability of actions identified via the action segmentation process flow. In the illustrated example of FIG. 2, causation determiner circuitry 250 operates upon the per-frame action prediction 125 generated by the AS model 108 to generate a causation prediction 205. The causation prediction identifies, for each frame in the input video, a corresponding preceding action that cause the identified action for the particular frame.

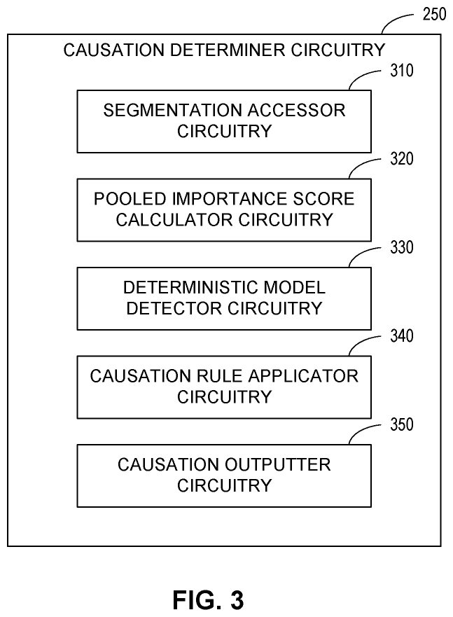

FIG. 3 is a block diagram of an example implementation of the causation determiner circuitry to provide causal explanation of per-frame action prediction. The causation determiner circuitry 250 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the causation determiner circuitry 250 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

In operation, the example causation determiner circuitry 205 executes five stages of operation to render a per-frame action prediction. Gradient information is propagated from the AS model prediction to input frame embeddings. In the second stage of the operation, the example causation determiner circuitry 205 aggregates the gradient information to approximate frame/action importance. The example causation determiner circuitry 205 then ranks past frames/actions as influential for the current time step prediction. Time step prediction involves predicting the value or label of a target variable at a future time step based on historical data. This knowledge can then be leveraged in a variety of useful ways, for instance to help explain prediction (e.g., causally) to a user in real-time. The knowledge also highlights previous action importance, and to convey system knowledge of current action relative to past action. In a HITL setting, the user can correct/amend this temporal analysis through dialogue prompts or other means of feedback.

In the first stage of operation, the example causation determiner circuitry 205 calculates the PIS of t^{th} frame of the input video 105. For example, yₐ^{T} denote the activation of the predicted action at frame T, and suppose {f}t denotes the set of features for the t^{th} frame. The causation determiner circuitry determines the importance of each previous frame t∈{1, . . . , t−1} with respect to the current frame (T) by calculating the magnitude of the gradient of yₐ^{T} with respect to each previous frame, as shown in the illustrated example of Equation 1.

$$\vert \frac{\partial {y}_{a}^{T}}{\partial {x}_{i}^{t}} \vert . \qquad Equation 1$$

In the illustrated example of Equation 1, the index i represents the i^{th} feature of the t^{th} frame of the input video 105. To determine the PIS of the of t^{th} frame of the input video 105, the causation determiner circuitry average these gradient magnitudes over the entire frame (t), as shown in the illustrated example of Equation 2.

$${PIS}_{t} = {\sum }_{i ϵ {\{ f \}}^{t}} \frac{1}{\vert {\{ f \}}^{t} \vert} \vert \frac{\partial {y}_{a}^{T}}{\partial {x}_{i}^{t}} \vert . \qquad Equation 2$$

In the illustrated example of Equation 2, {f}^{t} represents the set of features in the t^{th} frame of the input video 105, and |{f}^{t}| is the magnitude of this set of features. In the example FIG. 2, a schematic of the PIS calculation is shown.

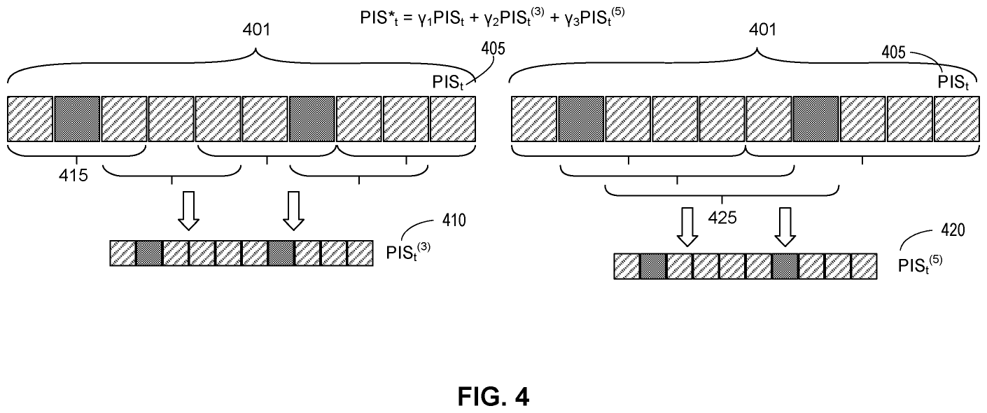

In the second stage of operation, the causation determiner circuitry 205 averages the PIS over several spatial scales to improve reliability and temporal consistency of the PIS. An example diagram illustrating the spatial scales is illustrated below in connection with FIG. 4. The spatial scales can be a neighborhood size of 1, 3, 5, or any other neighborhood size. The averaging operation is computed quickly in real-time using a one-dimensional (1-D) convolution operation. Using the PISₜ which denotes the pooled importance score as shown in example Equation 2, PISₜ⁽³⁾ and PISₜ⁽⁵⁾ denote the PIS for the t^{th} frame following a neighborhood size 3 and size 5 convolution operation respectively. A scaled importance score is calculated as a sum of PISₜ, PISₜ⁽³⁾ and PISₜ⁽⁵⁾, in a manner consistent with example Equation 3.

$${PIS}_{t}^{*} = {γ}_{1} {PIS}_{t} + {γ}_{2} {PIS}_{t}^{( 3 )} + {γ}_{3} {PIS}_{t}^{( 5 )} . \qquad Equation 3$$

To debias against more frequent actions for antecedent action prediction, the example causation determiner circuitry 205 averages the PIS over previous frames for each action class predicted.

In some examples, if the underlying AS model 108 is non-deterministic (i.e., the AS model 108 can generate multiple output predictions for a fixed input datum, such as in the case of a Bayesian Neural Network), to further improve robustness, the example causation determiner circuitry 205 averages these results over the Monte Carlo (MC) samples for the input video (e.g., a plurality of non-deterministic action segmentation outputs of the AS model 108). If desired, the AS model 108 can be converted into a BNN, and then the results for the BNN version of the AS model 108 can be utilized.

In some examples, the example causation determiner circuitry 205 apples one or more rules to the predicted causation(s). These rules (e.g., logic) enable the causation determiner circuitry 205 to provide more sensible and/or interpretable results, (e.g., prohibit antecedent action prediction as “idle”, current action is excluded as antecedent action, etc.) These rules can be tailored to the desire outcome for the current use case.

To accomplish this, the example causation determiner circuitry 250 includes example segmentation accessor circuitry 310, example pooled importance score calculator circuitry 320, example deterministic model detector circuitry 330, example causation rule applicator circuitry 340, and example causation outputter circuitry 350.

The segmentation accessor circuitry 310 obtains action segmentation data from the pre-trained action segmentation model 108. The segmentation accessor circuitry 310 is agnostic to the action segmentation model. Thus, many different model(s) and/or model type(s) may be used. The action segmentation model outputs per-frame action prediction. The segmentation accessor circuitry 310 access the action segmentation data indicating action prediction for multiple frames of a video sequence. The action segmentation data identifies the detected actions by frame of a video.

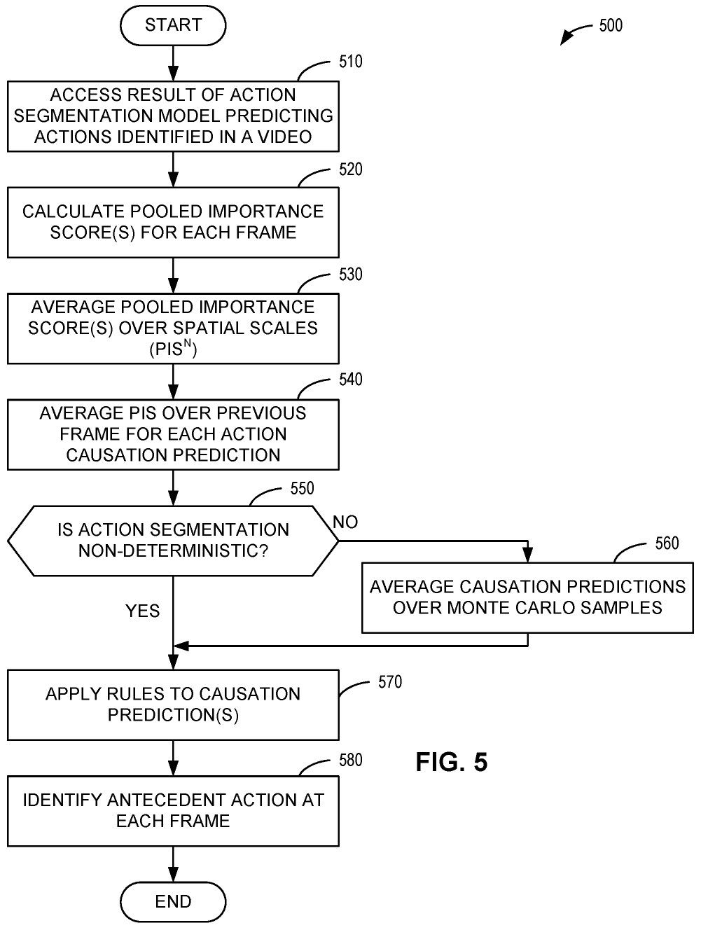

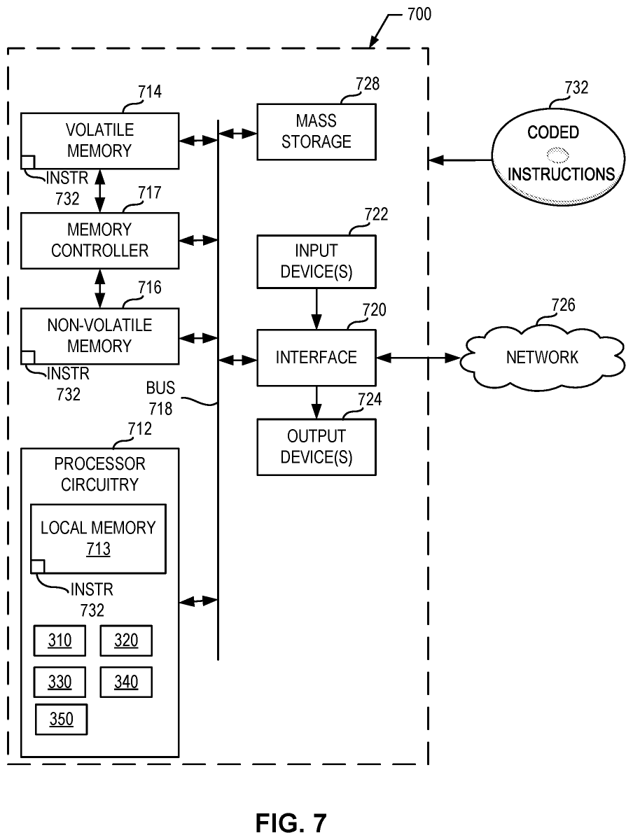

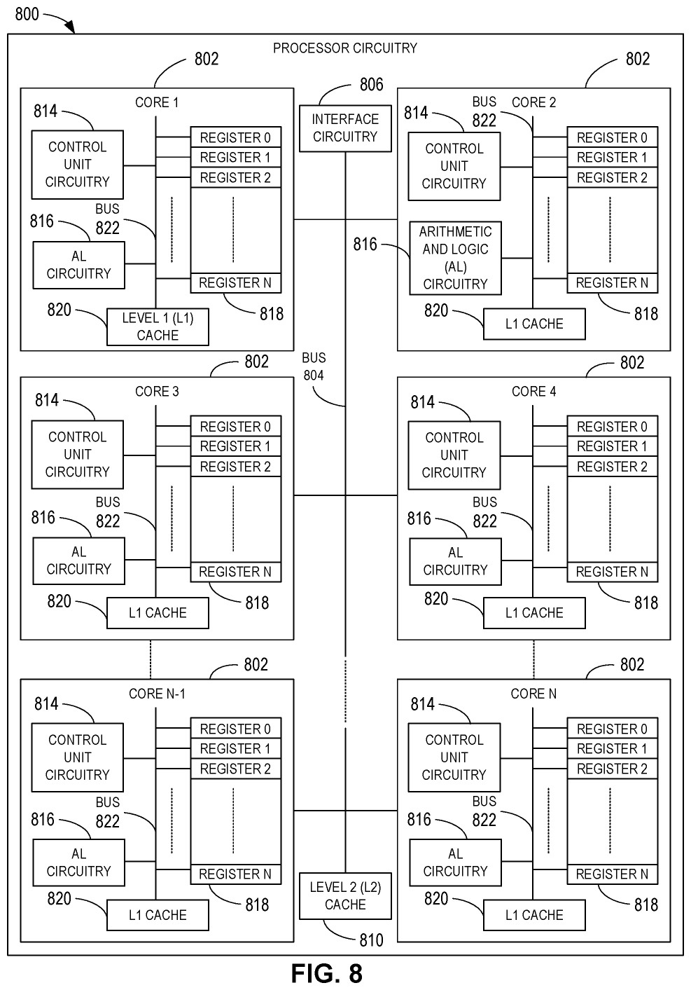

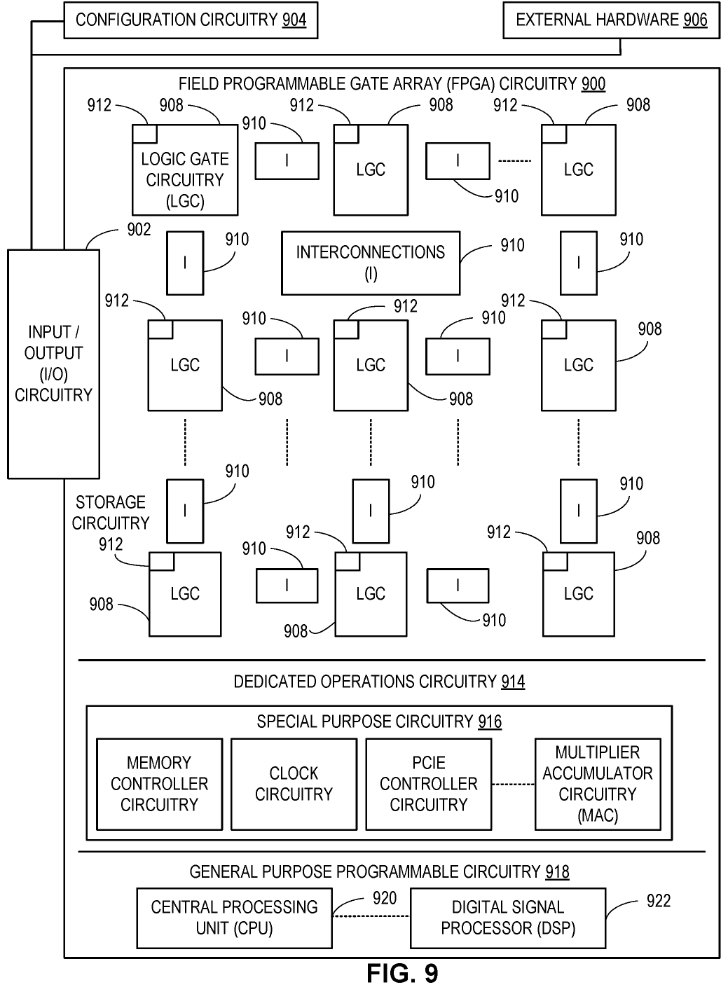

In some examples, the causation determiner circuitry 250 includes means for obtaining action segmentation data. For example, the means for obtaining may be implemented by the segmentation accessor circuitry 310. In some examples, the segmentation accessor circuitry 310 may be instantiated by programmable circuitry such as the example programmable circuitry 712 of FIG. 7. For instance, the segmentation accessor circuitry 310 may be instantiated by the example microprocessor 800 of FIG. 8 executing machine executable instructions such as those implemented by at least blocks 510 of FIG. 5. In some examples, the segmentation accessor circuitry 310 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the segmentation accessor circuitry 310 may be instantiated by any other combination of hardware, software, and/or firmware. For example, the segmentation accessor circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The pooled importance score calculator circuitry 320 calculates pooled importance score (PIS) for each frame by combining the obtained action segmentation data with input features extracted from the plurality of video frames. The features in the action segmentation data represent a likelihood of a corresponding action being depicted in a frame. The pooled importance score calculator circuitry 320 calculates first importance scores for a first frame of the action segmentation data. The first importance score represents respective importance of features identified in the action segmentation data for the first frame. The first importance scores are based on gradient magnitudes of features identified in prior frames.

The pooled importance score calculator circuitry 320 calculates first averaged importance scores based on the first importance scores and second importance scores. The first averaged importance scores are associated with the first frame, and the second importance scores corresponding to a second frame that is adjacent the first frame. The pooled importance scores for the first frame are calculated by combining the first importance scores and the first averaged importance scores. The first averaged importance scores are performed based on a first weight value applied to the first importance scores.

The pooled importance score calculator circuitry 320 calculates second averaged importance scores over spatial scales (e.g., over a neighborhood). In some examples, the spatial scales can be a neighborhood window size of 3 where the second averaged importance scores is based on the first importance scores, the second importance scores, and third importance scores. The third importance scores corresponding to a third frame that is adjacent to the second frame. The pooled importance scores are further based on the second averaged importance scores. The second averaged importance scores based on a second weight value applied to the second importance scores.

The pooled importance score calculator circuitry 320 averages the pooled importance scores over previous frames for each feature identified in the action segmentation data.

In some examples, the causation determiner circuitry 250 includes means for calculating pooled importance score. For example, the means for calculating may be implemented by the pooled importance score calculator circuitry 320. In some examples, the pooled importance score calculator circuitry 320 may be instantiated by programmable circuitry such as the example programmable circuitry 712 of FIG. 7. For instance, the pooled importance score calculator circuitry 320 may be instantiated by the example microprocessor 800 of FIG. 8 executing machine executable instructions such as those implemented by at least blocks 520, 530, 540 of FIG. 5. In some examples, the pooled importance score calculator circuitry 320 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the pooled importance score calculator circuitry 320 may be instantiated by any other combination of hardware, software, and/or firmware. For example, the pooled importance score calculator circuitry 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The deterministic model detector circuitry 330 of the illustrated example of FIG. 3 determines whether the AS model 108 that provided the action segmentation data is non-deterministic or deterministic. If the AS model 108 provides an output that is non-deterministic, the deterministic model detector circuitry 330 averages causation predictions over Monte Carlo samples of the input video. The Monte Carlo samples are random sampling of frames or segments from the input video to generate random samples. In some examples, if the AS model is non-deterministic, the deterministic model detector circuitry 330 may trigger creation of a deterministic version of the AS model 108 and may then operate based on the output of the deterministic version of the AS model.

In some examples, the causation determiner circuitry 250 includes means for averaging causation predictions. For example, the means for averaging may be implemented by the deterministic model detector circuitry 330. In some examples, the deterministic model detector circuitry 330 may be instantiated by programmable circuitry such as the example programmable circuitry 712 of FIG. 7. For instance, the deterministic model detector circuitry 330 may be instantiated by the example microprocessor 800 of FIG. 8 executing machine executable instructions such as those implemented by at least blocks 550, 560 of FIG. 5. In some examples, the deterministic model detector circuitry 330 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the deterministic model detector circuitry 330 may be instantiated by any other combination of hardware, software, and/or firmware. For example, the deterministic model detector circuitry 330 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example causation rule applicator circuitry 340 of the illustrated example of FIG. 3 applies rules to causation predictions, which allow for filtering out erroneous causality predictions. In examples disclosed herein, these rules are hand-crafted logic that enable sensible and/or interpretable results to be created. For example, the rules can include prohibiting antecedent action prediction as “idle”, excluding current action as antecedent action, etc.

In some examples, the causation determiner circuitry 250 includes means for applying rules to causation predictions. For example, the means for applying rules may be implemented by the causation rule applicator circuitry 340. In some examples, the causation rule applicator circuitry 340 may be instantiated by programmable circuitry such as the example programmable circuitry 712 of FIG. 7. For instance, the causation rule applicator circuitry 340 may be instantiated by the example microprocessor 800 of FIG. 8 executing machine executable instructions such as those implemented by at least blocks 570 of FIG. 5. In some examples, the causation rule applicator circuitry 340 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the causation rule applicator circuitry 340 may be instantiated by any other combination of hardware, software, and/or firmware. For example, the causation rule applicator circuitry 340 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example causation outputter circuitry 350 of the illustrated example of FIG. 3 outputs an identification of an antecedent action of at least one frame of the video sequence based on pooled importance scores for the frame. In some examples, the antecedent action identifies an action class (e.g., a previous action and/or identifier thereof that caused an action of a given frame). However, in some other examples, the antecedent action may additionally or alternatively identify a prior frame having the predicted action class.

FIG. 4 illustrates calculation of pooled importance scores by neighborhood. For each input video frame 401, the importance scores are calculated for various frames or features within each frame of the input video. These scores can represent the saliency of regions, relevance of specific features, or any other measure of significance for a given task (e.g., action recognition, event detection). The PISₜ 405 represents the pooled importance score. The value PISₜ⁽³⁾ 410 is generated by averaging the importance scores PISₜ 405 over neighborhoods of size 3, 415. The value PISₜ⁽⁵⁾ 420 is generated by averaging the importance scores PISₜ 405 over neighborhoods of size 5, 425. Other neighborhood sizes may additionally or alternatively be used.

In some examples, the causation determiner circuitry 250 includes means for identifying an antecedent action. For example, the means for identifying may be implemented by the causation outputter circuitry 350. In some examples, the causation outputter circuitry 350 may be instantiated by programmable circuitry such as the example programmable circuitry 712 of FIG. 7. For instance, the causation outputter circuitry 350 may be instantiated by the example microprocessor 800 of FIG. 8 executing machine executable instructions such as those implemented by at least block 580 of FIG. 5. In some examples, the causation outputter circuitry 350 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the causation outputter circuitry 350 may be instantiated by any other combination of hardware, software, and/or firmware. For example, the causation outputter circuitry 350 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the causation determiner circuitry 250 of FIG. 1 is illustrated in FIG. 3, one or more of the elements, processes, and/or devices illustrated in FIG. 3 may be combined, divided, re-arranged, omitted, eliminated, and/or implemented in any other way. Further, the example segmentation accessor circuitry 310, the example model detector circuitry 330, the example causation rule applicator circuitry 340, and the example causation outputter circuitry 350, and/or, more generally, the example causation determiner circuitry 250 of FIG. 3, may be implemented by hardware alone or by hardware in combination with software and/or firmware. Thus, for example, any of the segmentation accessor circuitry 310, example pooled importance score calculator circuitry 320, example deterministic model detector circuitry 330, example causation rule applicator circuitry 340, and example causation outputter circuitry 350, and/or, more generally, the example causation determiner circuitry 250, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example causation determiner circuitry 250 of FIG. 3 may include one or more elements, processes, and/or devices in addition to, or instead of, those illustrated in FIG. 3, and/or may include more than one of any or all of the illustrated elements, processes, and devices.

A flowchart representative of example machine readable instructions, which may be executed by programmable circuitry to implement and/or instantiate the causation determiner circuitry 250 of FIG. 3, are shown in FIG. 5. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 5, many other methods of implementing the example causation determiner circuitry 250 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 5 is a flowchart representative of example machine readable instructions and/or example operations 500 that may be executed, instantiated, and/or performed by programmable circuitry to render a per-frame action causation prediction. The example machine-readable instructions and/or the example operations 500 of FIG. 5 begin at block 510, at which the example segmentation accessor circuitry 310 (FIG. 3) access results of the AS model 108 predicting actions identified in a video.

The example pooled importance score calculator circuitry 320 (FIG. 3) calculates pooled importance score(s) (PIS) for each frame (block 520).

The pooled importance score calculator circuitry 320 averages the PIS(s) over spatial scales (PIS^{N}) (block 530).

The pooled importance score calculator circuitry 320 averages the PIS over previous frame for each action causation prediction (block 540).

The example deterministic model detector circuitry 330 determines whether an action segmentation is non-deterministic (block 550). An action segmentation is non-deterministic when a fixed input datum generates multiple output predictions. If the action segmentation is not non-deterministic (e.g., block 550 returns a result of NO), the deterministic model detector circuitry 330 averages the causation predictions over Monte Carlo samples (block 560). Control proceeds to block 570.

If the action segmentation model 108 is non-deterministic (block 550: YES), or after averaging of the causation predictions over Monte Carlo samples (block 560), the example causation rule applicator circuitry 340 apply rules to the causation prediction (block 570). In examples disclosed herein, the rules are implemented as logic that directs particular causation predictions to be made or not made. For example, such logic may prohibit antecedent action prediction such as “idle”, exclude current action as antecedent action, etc.

The example causation outputter circuitry 350 identifies an antecedent action at each frame (block 580). The antecedent action is based on the PISs after having had the rules applied at block 570. The example instructions and/or operations 500 of FIG. 5 end, but may be re-executed to generate additional causation predictions.

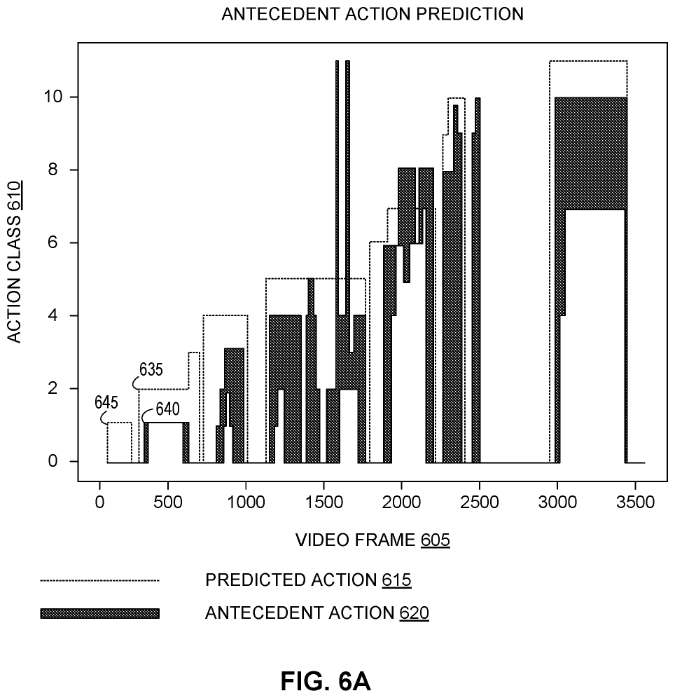

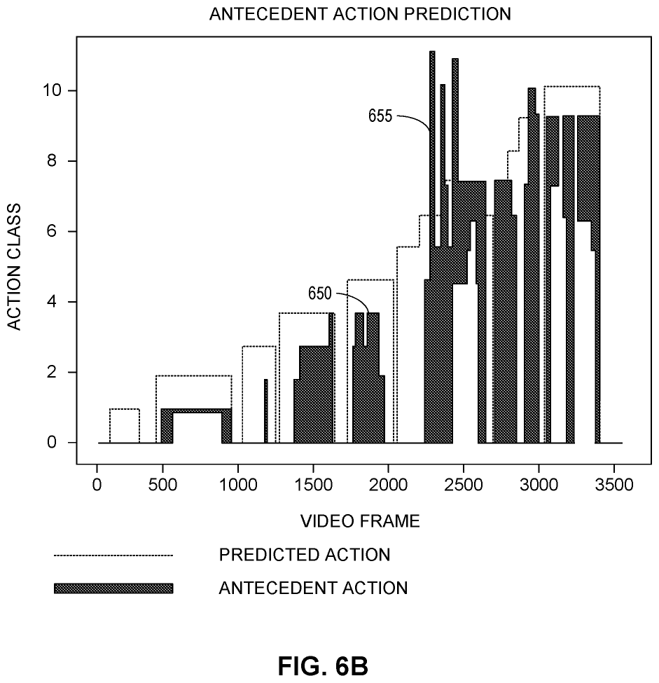

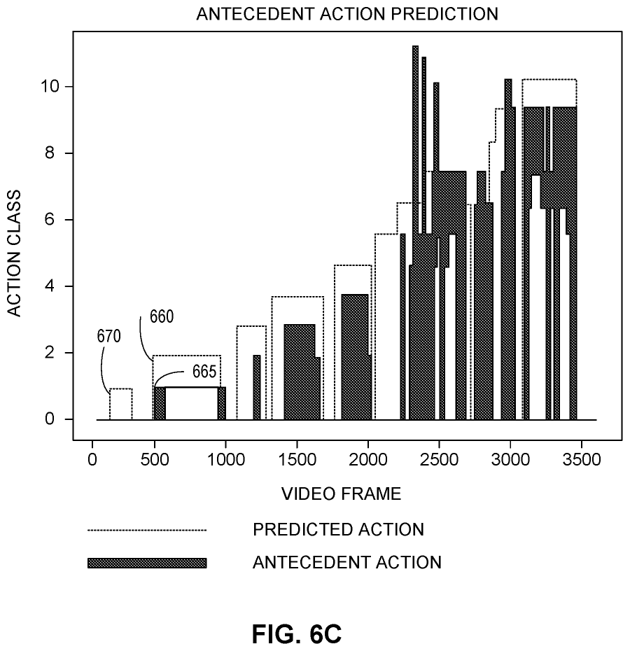

FIG. 6A illustrates an example experimental results graph for a test video using CUVAS with the example causation determiner circuitry 250 for antecedent action prediction. In the example graph of FIG. 6A, the x-axis 605 displays the number of video frames. The y-axis 610 represents the action class. The graph is a bar graph with two values being displayed. First values 615 (represented using a dashed line) represent a class of a predicted action (e.g., a result of the AS model 108). Second values 620 (represented using a solid line) represent a class of a predicted antecedent action. In the illustrated example of FIG. 6A, the input video was an example manufacturing process video where actions are performed in an incrementing sequence (e.g., the action class label is expected to increment throughout the duration of the process). The dataset included thirteen individual class actions. The graph illustrates that the predicted action from the AS model is accurately predicted based on the antecedent action before it. For example, an antecedent action 640 is predicted, accurately identifying a prior action 645 as the antecedent action for a currently identified action 635.

FIG. 6B illustrates another example experimental results graph for a second test video using CUVAS with causation determiner circuitry 250 for antecedent action prediction. The results align with the causal intuitions for this manufacturing process dataset, including the inherent sequentiality of this process. For example, action class two follows the completion of action class one. Action class three follows the completion of action class two, and so on. However, several action classes (e.g., action classes eight through ten) are part of a multi-stage process that begins with process eight. Example approaches disclosed herein identify this sequence of causality correctly in the experimental results. Although some frames of the antecedent action prediction are somewhat noisy (e.g., frames 650, 655), the degree of temporal smoothness of the antecedent action prediction can be adjusted based on the weight values used in Equation 3.

FIG. 6C illustrates another example experimental results graph for a third test video using CUVAS with causation determiner circuitry 250 for antecedent action prediction. The results also illustrates that the antecedent action 665 accurately identifies the previously predicted action 670 for the current action 660.

FIG. 7 is a block diagram of an example programmable circuitry platform 700 structured to execute and/or instantiate the example machine-readable instructions and/or the example operations of FIG. 5 to implement the causation determiner circuitry 250 of FIG. 3. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example segmentation accessor circuitry 310, the example model detector circuitry 330, the example causation rule applicator circuitry 340, and the example causation outputter circuitry 350, and/or, more generally, the example causation determiner circuitry 250.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIG. 5, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowchart of FIG. 5 to effectively instantiate the circuitry of FIG. 2 as logic circuits to perform operations corresponding to those machine readable instructions. In some such examples, the circuitry of FIG. 3 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowchart of FIG. 5.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart of FIG. 5 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart of FIG. 5. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 5. As such, the FPGA circuitry 900 may be configured and/or structured to effectively instantiate some or all of the operations/functions corresponding to the machine readable instructions of the flowchart of FIG. 5 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIG. 5 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIG. 5 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIG. 5 to perform first operation(s)/function(s), the FPGA circuitry 900 of FIG. 9 may be configured and/or structured to perform second operation(s)/function(s) corresponding to a second portion of the machine readable instructions represented by the flowchart of FIG. 5, and/or an ASIC may be configured and/or structured to perform third operation(s)/function(s) corresponding to a third portion of the machine readable instructions represented by the flowchart of FIG. 5.

It should be understood that some or all of the circuitry of FIG. 3 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 3 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

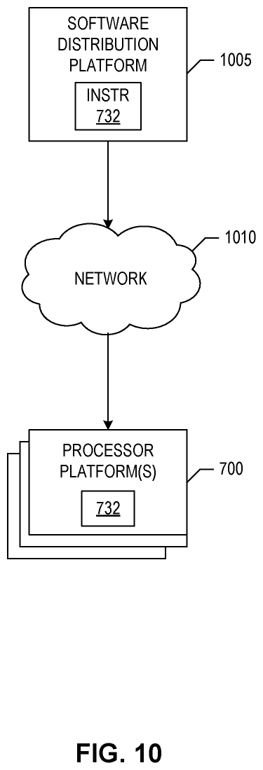

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIG. 5, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. 5, may be downloaded to the example programmable circuitry platform 700, which is to execute the machine readable instructions 732 to implement the causation determiner circuitry 250. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enhance action segmentation model with causal explanation capability. More particularly, examples disclosed herein resolve challenges of precise, fine-grain action segmentation for long-duration videos. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to enhance action segmentation model with causal explanation capability are disclosed herein. Further examples and combinations thereof include the following:

Example 1 includes an apparatus comprising interface circuitry to access a pre-trained action segmentation model, machine readable instructions, and at least one processor circuit to at least one of instantiate or execute the machine readable instructions to obtain action segmentation data from the pre-trained action segmentation model, the action segmentation data indicating action prediction for one or more frames of a video sequence, combine the obtained action segmentation data with input features extracted from the one or more frames of the video sequence, and identify an antecedent action of at least one frame of the video sequence based on pooled importance scores for the frame, the pooled importance scores being calculated from the combined action segmentation data and the input features.

Example 2 includes the apparatus of example 1, wherein one or more of the at least one processor circuit is to calculate first importance scores for a first frame of the action segmentation data, the first importance scores representing respective importances of features identified in the action segmentation data for the first frame, the first importance scores based on gradient magnitudes of features identified in prior frames, calculate first averaged importance scores based on the first importance scores and second importance scores, the first averaged importance scores associated with the first frame, the second importance scores corresponding to a second frame that is adjacent the first frame, combine the first importance scores and the first averaged importance scores to create the pooled importance scores for the first frame, and identify the antecedent action of the first frame based on the pooled importance scores for the first frame.

Example 3 includes the apparatus of example 2, wherein one or more of the at least one processor circuit is to calculate second averaged importance scores based on the first importance scores, the second importance scores, and third importance scores, the third importance scores corresponding to a third frame that is adjacent to the second frame, wherein the pooled importance scores are further based on the second averaged importance scores.

Example 4 includes the apparatus of example 3, wherein the combination of the first averaged importance scores and the second averaged importance scores is performed based on a first weight value applied to the first importance scores and a second weight value applied to the second importance scores.

Example 5 includes the apparatus of example 2, wherein one or more of the at least one processor circuit is to average the pooled importance scores over previous frames for each feature identified in the action segmentation data.

Example 6 includes the apparatus of example 1, wherein the action segmentation data identifies detected actions by frame of a video.

Example 7 includes the apparatus of example 1, wherein the input features in the action segmentation data represent a likelihood of a corresponding action being depicted in the frame.

Example 8 includes the apparatus of example 1, wherein the pre-trained action segmentation model is non-deterministic, one or more of the at least one processor circuit is to average causation predictions over a plurality of action segmentation outputs of the pre-trained action segmentation model.

Example 9 includes the apparatus of example 8, wherein one or more of the at least one processor circuit is to apply a rule to the causation predictions to remove at least one causality prediction.

Example 10 includes At least one non-transitory computer-readable medium comprising instructions to cause at least one processor circuit to at least obtain action segmentation data from a pre-trained action segmentation model, the action segmentation data indicating action prediction for one or more frames of a video sequence, combine the obtained action segmentation data with input features extracted from the one or more frames of the video sequence, and identify an antecedent action of at least one frame of the video sequence based on pooled importance scores for the frame, the pooled importance scores being calculated from the combined action segmentation data and the input features.

Example 11 includes the at least one non-transitory computer-readable medium of example 10, wherein the instructions are to cause one or more of the at least one processor circuit to calculate first importance scores for a first frame of the action segmentation data, the first importance scores representing respective importances of features identified in the action segmentation data for the first frame, the first importance scores based on gradient magnitudes of features identified in prior frames, calculate first averaged importance scores based on the first importance scores and second importance scores, the first averaged importance scores associated with the first frame, the second importance scores corresponding to a second frame that is adjacent the first frame, combine the first importance scores and the first averaged importance scores to create the pooled importance scores for the first frame, and identify the antecedent action of the first frame based on the pooled importance scores for the first frame.

Example 12 includes the at least one non-transitory computer-readable medium of example 11, wherein the instructions are to cause one or more of the at least one processor circuit to calculate second averaged importance scores based on the first importance scores, the second importance scores, and third importance scores, the third importance scores corresponding to a third frame that is adjacent to the second frame, wherein the pooled importance scores are further based on the second averaged importance scores.

Example 13 includes the at least one non-transitory computer-readable medium of example 12, wherein the combination of the first averaged importance scores and the second averaged importance scores is performed based on a first weight value applied to the first importance scores and a second weight value applied to the second importance scores.

Example 14 includes the at least one non-transitory computer-readable medium of example 11, wherein the instructions are to cause one or more of the at least one processor circuit to average the pooled importance scores over previous frames for each feature identified in the action segmentation data.

Example 15 includes the at least one non-transitory computer-readable medium of example 10, wherein the action segmentation data identifies detected actions by frame of a video.

Example 16 includes the at least one non-transitory computer-readable medium of example 10, wherein the input features in the action segmentation data represent a likelihood of a corresponding action being depicted in the frame.

Example 17 includes the at least one non-transitory computer-readable medium of example 10, wherein the action segmentation model is non-deterministic, one or more of the at least one processor circuit is to average causation predictions over a plurality of action segmentation outputs of the pre-trained action segmentation model.

Example 18 includes the at least one non-transitory computer-readable medium of example 17, wherein the instructions are to cause one or more of the at least one processor circuit to apply a rule to the causation predictions to remove at least one causality prediction.

Example 19 includes a method comprising obtaining action segmentation data from a pre-trained action segmentation model, the action segmentation data indicating action prediction for one or more frames of a video sequence, combining the obtained action segmentation data with input features extracted from the one or more frames of the video sequence, and identifying an antecedent action of at least one frame of the video sequence based on pooled importance scores for the frame, the pooled importance scores being calculated from the combined action segmentation data and the input features.

Example 20 includes the method of example 19, further including calculating first importance scores for a first frame of the action segmentation data, the first importance scores representing respective importances of features identified in the action segmentation data for the first frame, the first importance scores based on gradient magnitudes of features identified in prior frames, calculating first averaged importance scores based on the first importance scores and second importance scores, the first averaged importance scores associated with the first frame, the second importance scores corresponding to a second frame that is adjacent the first frame, combining the first importance scores and the first averaged importance scores to create the pooled importance scores for the first frame, and identifying the antecedent action of the first frame based on the pooled importance scores for the first frame.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry to access a pre-trained action segmentation model;
machine readable instructions; and
at least one processor circuit to at least one of instantiate or execute the machine readable instructions to:
obtain action segmentation data from the pre-trained action segmentation model, the action segmentation data indicating action prediction for one or more frames of a video sequence;
combine the obtained action segmentation data with input features extracted from the one or more frames of the video sequence; and
identify an antecedent action of at least one frame of the video sequence based on pooled importance scores for the frame, the pooled importance scores being calculated from the combined action segmentation data and the input features.

2. The apparatus of claim 1, wherein one or more of the at least one processor circuit is to:
calculate first importance scores for a first frame of the action segmentation data, the first importance scores representing respective importances of features identified in the action segmentation data for the first frame, the first importance scores based on gradient magnitudes of features identified in prior frames;
calculate first averaged importance scores based on the first importance scores and second importance scores, the first averaged importance scores associated with the first frame, the second importance scores corresponding to a second frame that is adjacent the first frame;
combine the first importance scores and the first averaged importance scores to create the pooled importance scores for the first frame; and
identify the antecedent action of the first frame based on the pooled importance scores for the first frame.

3. The apparatus of claim 2, wherein one or more of the at least one processor circuit is to calculate second averaged importance scores based on the first importance scores, the second importance scores, and third importance scores, the third importance scores corresponding to a third frame that is adjacent to the second frame, wherein the pooled importance scores are further based on the second averaged importance scores.

4. The apparatus of claim 3, wherein the combination of the first averaged importance scores and the second averaged importance scores is performed based on a first weight value applied to the first importance scores and a second weight value applied to the second importance scores.

5. The apparatus of claim 2, wherein one or more of the at least one processor circuit is to average the pooled importance scores over previous frames for each feature identified in the action segmentation data.

6. The apparatus of claim 1, wherein the action segmentation data identifies detected actions by frame of a video.

7. The apparatus of claim 1, wherein the input features in the action segmentation data represent a likelihood of a corresponding action being depicted in the frame.

8. The apparatus of claim 1, wherein the pre-trained action segmentation model is non-deterministic, one or more of the at least one processor circuit is to average causation predictions over a plurality of action segmentation outputs of the pre-trained action segmentation model.

9. The apparatus of claim 8, wherein one or more of the at least one processor circuit is to apply a rule to the causation predictions to remove at least one causality prediction.

10. At least one non-transitory computer-readable medium comprising instructions to cause at least one processor circuit to at least:
obtain action segmentation data from a pre-trained action segmentation model, the action segmentation data indicating action prediction for one or more frames of a video sequence;
combine the obtained action segmentation data with input features extracted from the one or more frames of the video sequence; and
identify an antecedent action of at least one frame of the video sequence based on pooled importance scores for the frame, the pooled importance scores being calculated from the combined action segmentation data and the input features.

11. The at least one non-transitory computer-readable medium of claim 10, wherein the instructions are to cause one or more of the at least one processor circuit to:
calculate first importance scores for a first frame of the action segmentation data, the first importance scores representing respective importances of features identified in the action segmentation data for the first frame, the first importance scores based on gradient magnitudes of features identified in prior frames;
calculate first averaged importance scores based on the first importance scores and second importance scores, the first averaged importance scores associated with the first frame, the second importance scores corresponding to a second frame that is adjacent the first frame;
combine the first importance scores and the first averaged importance scores to create the pooled importance scores for the first frame; and
identify the antecedent action of the first frame based on the pooled importance scores for the first frame.

12. The at least one non-transitory computer-readable medium of claim 11, wherein the instructions are to cause one or more of the at least one processor circuit to calculate second averaged importance scores based on the first importance scores, the second importance scores, and third importance scores, the third importance scores corresponding to a third frame that is adjacent to the second frame, wherein the pooled importance scores are further based on the second averaged importance scores.

13. The at least one non-transitory computer-readable medium of claim 12, wherein the combination of the first averaged importance scores and the second averaged importance scores is performed based on a first weight value applied to the first importance scores and a second weight value applied to the second importance scores.

14. The at least one non-transitory computer-readable medium of claim 11, wherein the instructions are to cause one or more of the at least one processor circuit to average the pooled importance scores over previous frames for each feature identified in the action segmentation data.

15. The at least one non-transitory computer-readable medium of claim 10, wherein the action segmentation data identifies detected actions by frame of a video.

16. The at least one non-transitory computer-readable medium of claim 10, wherein the input features in the action segmentation data represent a likelihood of a corresponding action being depicted in the frame.

17. The at least one non-transitory computer-readable medium of claim 10, wherein the action segmentation model is non-deterministic, one or more of the at least one processor circuit is to average causation predictions over a plurality of action segmentation outputs of the pre-trained action segmentation model.

18. The at least one non-transitory computer-readable medium of claim 17, wherein the instructions are to cause one or more of the at least one processor circuit to apply a rule to the causation predictions to remove at least one causality prediction.

19. A method comprising:
obtaining action segmentation data from a pre-trained action segmentation model, the action segmentation data indicating action prediction for one or more frames of a video sequence;
combining the obtained action segmentation data with input features extracted from the one or more frames of the video sequence; and
identifying an antecedent action of at least one frame of the video sequence based on pooled importance scores for the frame, the pooled importance scores being calculated from the combined action segmentation data and the input features.

20. The method of claim 19, further including:
calculating first importance scores for a first frame of the action segmentation data, the first importance scores representing respective importances of features identified in the action segmentation data for the first frame, the first importance scores based on gradient magnitudes of features identified in prior frames;
calculating first averaged importance scores based on the first importance scores and second importance scores, the first averaged importance scores associated with the first frame, the second importance scores corresponding to a second frame that is adjacent the first frame;
combining the first importance scores and the first averaged importance scores to create the pooled importance scores for the first frame; and
identifying the antecedent action of the first frame based on the pooled importance scores for the first frame.
